(19) United States
(12) Patent Application Publication
(10) Pub. No.: US 2003/0043421 A1
(43) Pub. Date: Mar. 6, 2003

(54) Scanner which has compensation elements to increase its scanning speed

(76) Inventor: Chang-Lin Pi, Kao-Hsiung Hsien (TW)

Correspondence Address: NAIPO (NORTH AMERICA INTERNATIONAL PATENT OFFICE), P.O. BOX 506, MERRIFIELD, VA, 22116, US

(21) Appl. No.: 10/064,353

(22) Filed: Jul. 4, 2002

(30) Foreign Application Priority Data
Aug. 30, 2001 (TW) 090214905

(51) Int. Cl. H04N 1/04

(52) U.S. Cl. 358/474

(57) ABSTRACT

A scanner includes a housing, a transparent platform, a scanning module, a motor, a front compensation element and a rear compensation element. The housing includes a front section, a rear section, and a scanning section. The transparent platform is installed on the housing for a document to be placed on. The scanning module is installed inside the housing for scanning the document. The motor is used to drive the scanning module. The front and rear compensation elements are installed inside the housing to assist the motor with starting and stopping the scanning module.

### BACKGROUND OF INVENTION

1. Field of the Invention

The present invention relates to a scanner. More specifically, the present invention discloses a scanner having compensation elements for increasing operation speed of a scanning module of the scanner.

2. Description of the Prior Art

A scanner is a widespread peripheral device for scanning documents and producing corresponding image data. The scanner may have some additional functions, such as faxing image data to a fax machine over telephone lines, transmitting the image data in an e-mail format over a network, or connecting to a printer to print the image data.

Please refer to FIG. 1. FIG. 1 is a diagram of a scanner 10 according to the prior art. The scanner 10 comprises a housing 12, a transparent platform 18 installed on the housing 12 for a document 20 to be placed on, a sliding rod 22 installed inside the housing 12, a scanning module 14 slidably installed inside the housing 12 for scanning the document 20 along the sliding rod 22 so as to generate corresponding image signals of the document 20, and a step motor 16 installed inside the housing 12 and electrically connected to the scanning module 14 for driving the scanning module 14 to move back and forth in a stepping manner so as to perform a scanning process.

Please refer to FIG. 2. FIG. 2 is a top view of the scanner 10 according to the prior art. As shown in FIG. 2, the housing 12 of the scanner 10 comprises a front section 24, a rear section 26, and a document scanning section 28 between the front section 24 and the rear section 26. The front section 24 is a region where the scanning module 14 is accelerated from a motionless state to a constant scanning speed, the rear section 26 is a region where the scanning module 14 is decelerated from the constant scanning speed to the motionless state, and the document scanning section 28 is a region where the scanning module 14 scans the document 20.

When the step motor 16 initiates to drive the scanning module 14 in the front section 24 to move backwards from a front end 30 of the housing 12, the step motor 16 provides a torsional force to accelerate the scanning module 14 from the motionless state to the constant scanning speed, and then utilizes the constant scanning speed to perform the scanning process in the document scanning section 28. Nevertheless, the scanning module 14 has a large weight so that the step motor 16 usually needs a long period of time and a long distance in the front section 24 to accelerate the scanning module 14 to the constant scanning speed. When the scanning module 14 completes the scanning process and moves to the rear section 26, the step motor 16 reduces the torsional force to decelerate the scanning module 14 from the constant scanning speed to stop. The step motor 16 also needs a long period of time and a long distance in the rear section 26 to decelerate the scanning module 14 to stop, due to the large weight of the scanning module 14. Likewise, the aforementioned process will occur when the step motor 16 drives the scanning module 14 to move forwards from a rear end 32 of the housing 12 to the front end 30 of the housing 12. As mentioned above, the step motor 16 needs a long period of acceleration time and deceleration time to respectively initiate and stop the scanning module 14, meaning that the front section 24 and the rear section 26 will occupy a large space in the housing 12.

### SUMMARY OF INVENTION

It is therefore a primary objective of the claimed invention to provide a scanner having a front compensation element and a rear compensation element for increasing operation speed of a scanning module of the scanner.

The claimed invention, briefly summarized, discloses a scanner. The scanner comprises a housing, a transparent platform, a scanning module, a motor, a front compensation element, and a rear compensation element. The housing comprises a front section, a rear section, and a scanning section. The transparent platform is installed on the housing for a document to be placed on. The scanning module is installed inside the housing for scanning the document. The motor is used to drive the scanning module. The front and rear compensation elements are installed inside the housing to assist the motor with starting and stopping the scanning module.

It is an advantage of the claimed invention that the scanner can scan quickly by reducing the acceleration time and the deceleration time of the scanning module when the step motor initiates or stops the scanning module, and can further reduce space of the front section and the rear section so as to increase a scanning range of the document scanning section.

These and other objectives and advantages of the present invention will no doubt become obvious to those of ordinary skill in the art after reading the following detailed description of the preferred embodiment that is illustrated in the various figures and drawings.

### BRIEF DESCRIPTION OF DRAWINGS

FIG. 1 is a diagram of a scanner according to the prior art.

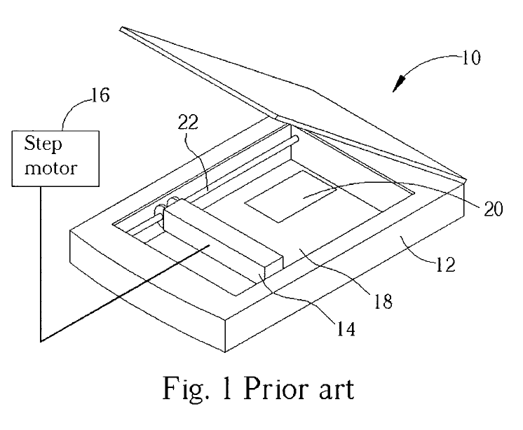

FIG. 2 is a top view of the scanner depicted in FIG. 1.

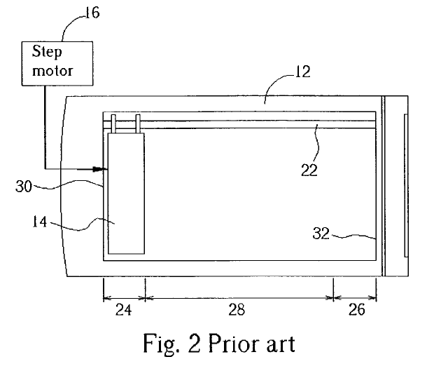

FIG. 3 is a diagram of a scanner according to the first preferred embodiment of the present invention.

FIG. 4 is a top view of the scanner depicted in FIG. 3.

FIG. 5 is a top view a scanner according to the second preferred embodiment of the present invention.

### DETAILED DESCRIPTION

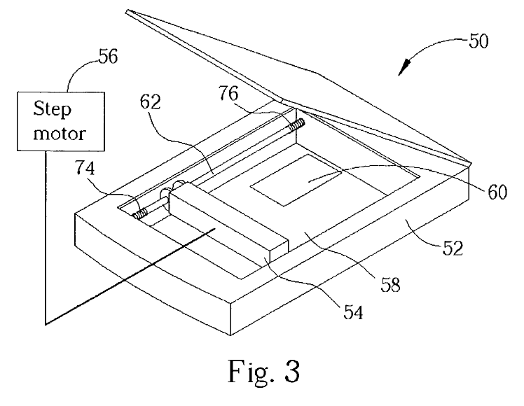

Please refer to FIG. 3. FIG. 3 is a diagram of a scanner 50 according to the first preferred embodiment of the present invention. As shown in FIG. 3, the scanner 50 comprises a housing 52, a transparent platform 58 installed on the housing 52 for a document 60 to be placed on, a sliding rod 62 installed inside the housing 52, a scanning module 54 slidably installed inside the housing 52 for scanning the document 60 along the sliding rod 62 so as to generate corresponding image signals of the document 60, a step motor 56 installed inside the housing 52 and electrically connected to the scanning module 54 for driving the scanning module 54 to move back and forth in a stepping manner so as to perform a scanning process, a front compensation element 74 installed at a front end of the sliding rod 62 of the housing 52, and a rear compensation element 76 installed at a rear end of the sliding rod 62 of the housing 52.

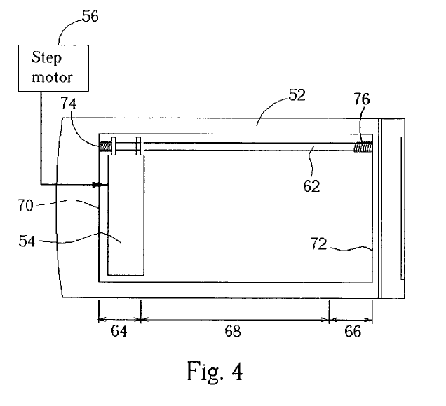

Please refer to FIG. 4. FIG. 4 is a top view of the scanner 50 depicted in FIG. 3. As shown in FIG. 4, the housing 52 of the scanner 50 comprises a front section 64, a rear section 66, and a document scanning section 68 between the front section 64 and the rear section 66. The front section 64 is a region where the scanning module 54 is accelerated from a motionless state to a constant scanning speed, the rear section 66 is a region where the scanning module 54 is decelerated from the constant scanning speed to the motionless state, and the document scanning section 68 is a region where the scanning module 54 scans the document 60.

The front compensation element 74 and the rear compensation element 76 are both springs for storing and releasing elasticity. When the scanning module 54 of the scanner 50 is motionless, the scanning module 54 is locked at a front end 70 of the housing 52 by the step motor 56 so as to depress the front compensation element 74 to store elasticity. When the step motor 56 initiates to drive the scanning module 54 to move backwards from the front end 70 of the housing 52, elasticity stored in the front compensation element 74 will be released to push the scanning module 54 positioned at the front section 64 backwards so as to quickly help the step motor 56 accelerate the scanning module 54 to a scanning speed. Shortening the acceleration time of the scanning module 54 initiated by the step motor 56 will allow the scanning module 54 to perform the scanning process swiftly, and to shorten a distance of the front section 64 while the scanning module 54 accelerates. When the scanning module 54 completes the scanning process and moves to the rear section 66, the rear compensation element 76 positioning at a rear end of the rear section 66 will provide a force to push the scanning module 54 so as to reduce the deceleration time of the scanning module 54 that is stopped by the step motor 56, and to shorten a distance of the rear section 66. While the step motor 56 drives the scanning module 54 to move toward a rear end 72 of the housing 52, the scanning module 54 depresses the rear compensation element 76 to store elasticity. This elasticity will be used to help the step motor 56 to initiate the scanning module quickly in the following scanning pass.

Likewise, when the step motor 56 initiates to drive the scanning module 54 to move forwards from the rear end 72 of the housing 52, the rear compensation element 76 will push the scanning module 54 in the rear section 66 so as to rapidly accelerate the scanning module 54 to the scanning speed. Furthermore, when the scanning module 54 completes the scanning process and moves to the front section 64, the front compensation element 74 will provide a force to push the scanning module 54 in the front section 64 so as to quickly decelerate the scanning module 54 to stop. The front compensation element 74 will be depressed to store elasticity again. Therefore, the present invention scanner 50 reduces the acceleration and deceleration time of the scanning module 54, and uses shorter distances in the front section 64 and the rear section 66.

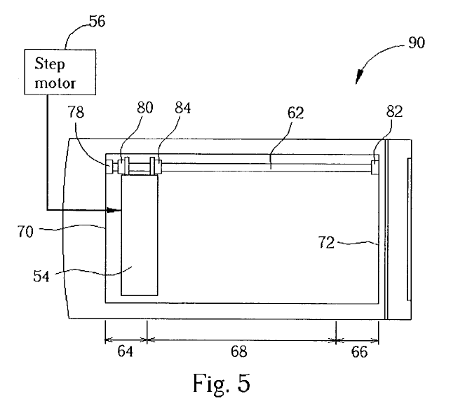

Please refer to FIG. 5. FIG. 5 is a top view a scanner 90 according to the second preferred embodiment of the present invention. The difference between the scanner 50 and the scanner 90 is that the front compensation element of the scanner 90 is a first magnetic element 78, and the scanner 90 further comprises a second magnetic element 80 installed on the scanning module 54. Polarity of the first magnetic element 78 faces the same polarity of the second magnetic element 80. Therefore, when the step motor 56 drives the scanning module 54 positioned at the front section 64 to move backwards away from the front end 70 of the housing 52, the first magnetic element 78 and the second magnetic element 80 repel each other so as to push the scanning module 54 to quickly accelerate to the scanning speed. Likewise, the rear compensation element of the scanner 90 is a third magnetic element 82, and the scanner 90 further comprises a fourth magnetic element 84 installed on the scanning module 54. Polarity of the third magnetic element 82 also faces the same polarity of the fourth magnetic element 84. As shown in FIG. 5, while the scanning module 54 completes the scanning process and moves backwards into the rear section 66, the third magnetic element 82 and the fourth magnetic element 84 also repel each other to prevent the scanning module 54 from moving backwards, and to quickly stop the scanning module 54.

Of course, the front compensation element (the first magnetic element 78 or the second magnetic element 80) and the rear compensation element (the third magnetic element 82 or the fourth magnetic element 84) of the present invention scanner 90 also can be used alone to urge the step motor 56 to initiate and stop the scanning module 54 in the front section 64 and the rear section 66 of the scanner 90, respectively. In addition, the step motor 56 of the scanners 50 and 90 can be installed at the front end or the rear end of the housing 52, on the scanning module 54, or inside the housing 52.

Nevertheless, the aforementioned descriptions utilize the step motor functioning as a driving device to drive the scanning module. The step motor has the same effect as the use of a DC motor or a servomotor.

In contrast to the prior art, the present invention scanners 50 and 90 have the front compensation element 74 (the first magnetic element 78 or the second magnetic element 80) for providing a force to push the scanning module 54 to quickly accelerate to the scanning speed while the step motor 56 initiates the scanning module 54, and the rear compensation element 76 (the third magnetic element 82 or the fourth magnetic element 84) for providing a force to push the scanning module 54 to rapidly decelerate while the step motor 56 stops the scanning module 54. The present invention allows fast scanning by reducing the acceleration time and the deceleration time of the scanning module 54 while the step motor 56 initiates or stops the scanning module 54. Furthermore, the present invention reduces space of the front section 64 and the rear section 66 so as to increase a scanning range of the document scanning section 68.

Those skilled in the art will readily observe that numerous modifications and alterations of the device may be made while retaining the teachings of the invention. Accordingly, the above disclosure should be construed as limited only by the metes and bounds of the appended claims.

What is claimed is:

1. A scanner comprising:
a housing having a front section, a rear section and a document scanning section between the front section and the rear section;
a transparent platform installed on the housing for a document to be placed on;
a scanning module installed inside the housing for scanning the document;
a motor for driving the scanning module; and
a front compensation element installed at a front end of the housing for providing a force to push the scanning module away from the front section of the housing;
wherein when the motor drives the scanning module to move backwards from the front end of the housing, the front compensation element provides the force to push the scanning module while the scanning module is in the front section so as to reduce an acceleration time of the scanning module.

2. The scanner of claim 1 wherein when the motor drive the scanning module to move forward toward the front end of the housing, the front compensation element provides a force to reduce a deceleration time of the scanning module while the scanning module is in the front section.

3. The scanner of claim 1 wherein the front compensation element is an elastic element.

4. The scanner of claim 3 wherein the elastic element is a spring.

5. The scanner of claim 1 wherein the front compensation element is a first magnetic element, the scanner further comprising a second magnetic element installed on the scanning module, a polarity of the first magnetic element facing the same polarity of the second magnetic element so that when the scanning module is in the front section, the first magnetic element and the second magnetic element repel each other.

6. The scanner of claim 1 further comprising a sliding rod fixed between the front end of the housing and a rear end of the housing, the scanning module sliding back and forth along the sliding rod inside the housing.

7. The scanner of claim 6 wherein the front compensation element is installed on the sliding rod.

8. The scanner of claim 1 wherein the motor is installed inside the housing.

9. The scanner of claim 1 wherein the motor is installed on the scanning module.

10. The scanner of claim 1 wherein the motor is a step motor.

11. The scanner of claim 1 further comprising a rear compensation element installed at a rear end of the housing for providing a force to push the scanning module away from the rear section of the housing wherein when the motor drives the scanning module to move forward from the rear end of the housing, the rear compensation element provides the force to push the scanning module while the scanning module is in the rear section so as to reduce an acceleration time of the scanning module.

12. The scanner of claim 1 wherein the motor is a servomotor.
